(19) United States
(12) Patent Application Publication
(10) Pub. No.: US 2019/0156695 A1
(43) Pub. Date: May 23, 2019

(54) LEARNING SYSTEM AND OPERATING METHOD OF THE SAME

(71) Applicant: National Taiwan Normal University, Taipei City (TW)

(72) Inventors: Ming-Yueh HWANG, Taipei City (TW); Jon-Chao HONG, Taipei City (TW)

(73) Assignee: National Taiwan Normal University, Taipei City (TW)

(21) Appl. No.: 16/059,316

(22) Filed: Aug. 9, 2018

(30) Foreign Application Priority Data
Nov. 17, 2017 (TW) 106139834

(51) Int. Cl. G09B 7/12; G09B 5/12

(52) U.S. Cl. CPC G09B 7/12; G09B 5/125

(57) ABSTRACT

A learning system includes signal transmitters disposed respectively at different areas, a portable electronic device, and a server storing various question banks associated respectively with pre-stored location data sets. An operation method of the learning system includes each signal transmitter broadcasting a location identifying data set, the portable electronic device transmitting a question request to the server upon receipt of the location identifying data set, the server transmitting to the portable electronic device a question in the question bank associated with the pre-stored location data set that conforms with the location identifying data set, and the portable electronic device outputting the question.

### CROSS-REFERENCE TO RELATED APPLICATION

This application claims priority to Taiwanese Patent Application No. 106139834 filed on Nov. 17, 2017.

### FIELD

The disclosure relates to a learning system and an operation method of the learning system.

### BACKGROUND

Nowadays, the path to acquiring knowledge is no longer limited to learning in classrooms. The United Nations Educational, Scientific and Cultural Organization (UNESCO) suggested that it is more effective to learn various concepts from daily life. Accordingly, it is worth working on the subject of learning through digital materials in daily life.

### SUMMARY

Therefore, an object of the present disclosure is to provide an operation method of a learning system and a learning system for encouraging users to learn from daily life.

According to one aspect of the present disclosure, an operation method of a learning system is provided. The learning system includes a plurality of signal transmitters that are disposed respectively at different areas in a store, a portable electronic device, and a server that stores a plurality of pre-stored location data sets related respectively to the areas in the store and a plurality of question banks associated respectively with the pre-stored location data sets. Each of the question banks is related to goods that are displayed in a corresponding one of the areas and includes a plurality of questions and a plurality of correct answers respectively to the questions. The operation method includes:
broadcasting, by each of the signal transmitters, a location identifying data set indicating the respective one of the areas where the signal transmitter is disposed;
upon receipt of the location identifying data set from one of the signal transmitters, transmitting, by the portable electronic device, a question request including the location identifying data set to the server;
in response to receipt of the question request, selecting, by the server, a corresponding one of the question banks associated with one of the pre-stored location data sets that conforms with the location identifying data set included in the question request;
transmitting, by the server, to the portable electronic device one of the questions included in the corresponding one of the question banks and the correct answer to said one of the questions;
outputting, by the portable electronic device, said one of the questions in response to receipt of said one of the questions and the correct answer thereto;
upon receipt of a user answer to said one of the question, determining, by the portable electronic device, whether the user answer conforms with the correct answer to said one of the questions;
when it is determined that the user answer conforms with the correct answer to said one of the questions, outputting, by the portable electronic device, a first notification indicating that the user answer is correct; and
when it is determined that the user answer does not conform with the correct answer to said one of the questions, outputting, by the portable electronic device, a second notification indicating that the user answer is not correct.

According to another aspect of the disclosure, a learning system is provided and includes a plurality of signal transmitters, a portable electronic device, and a server. The signal transmitters are disposed respectively at different areas in a store, and each of the signal transmitters is configured to broadcast a location identifying data set indicating the respective one of the areas where the signal transmitter is disposed. The server stores a plurality of pre-stored location data sets related respectively to the areas in the store and a plurality of question banks associated respectively with the pre-stored location data sets. Each of the question banks is related to goods that are displayed in a corresponding one of the areas and including a plurality of questions and a plurality of correct answers respectively to the questions. The portable electronic device is configured to, upon receipt of the location identifying data set from one of the signal transmitters, transmit a question request including the location identifying data set to the server. The server is configured, in response to receipt of the question request, to select a corresponding one of the question banks associated with one of the pre-stored location data sets that conforms with the location identifying data set included in the question request, and to transmit, to said portable electronic device, one of the questions included in the corresponding one of the question banks and the correct answer to the one of the questions.

The portable electronic device is further configured to:
output said one of the questions in response to receipt of said one of the questions and the correct answer thereto;
determine whether the user answer conforms with the correct answer to said one of the questions upon receipt of a user answer to said one of the question;
output a first notification indicating that the user answer is correct when determining that the user answer conforms with the correct answer to said one of the questions; and
output a second notification indicating that the user answer is not correct when determining that the user answer does not conform with the correct answer to said one of the questions.

### BRIEF DESCRIPTION OF THE DRAWINGS

Other features and advantages of the present disclosure will become apparent in the following detailed description of the embodiments with reference to the accompanying drawings, of which:

FIG. 1 is a schematic block diagram of a learning system according to one embodiment of the present disclosure; and

FIG. 2 is a flow chart illustrating an operation method of the learning system according to one embodiment of the present disclosure.

### DETAILED DESCRIPTION

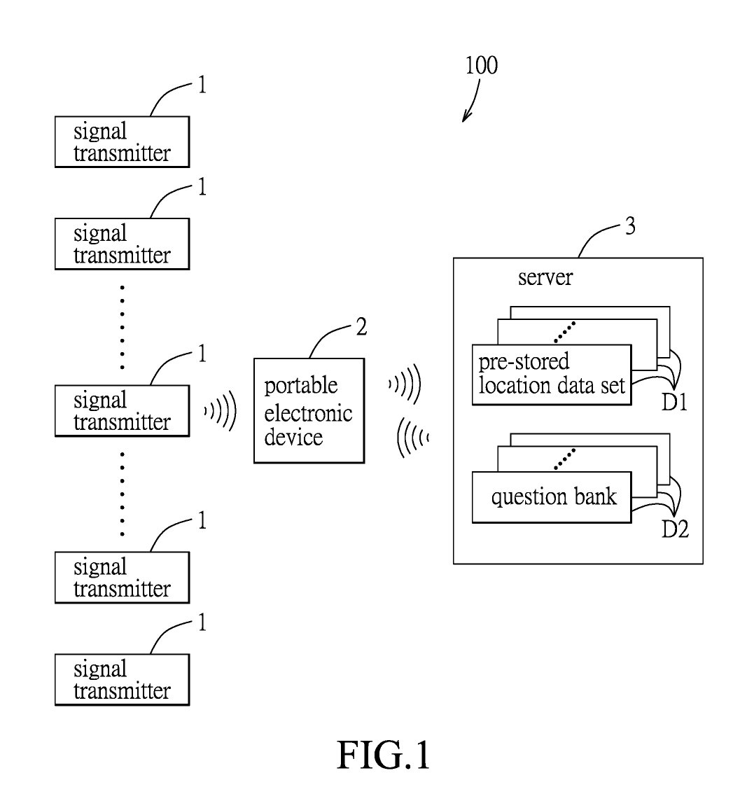

Referring to FIG. 1, a learning system. 100 according to an embodiment of the present disclosure includes a plurality of signal transmitters 1, a portable electronic device 2 and a server 3.

The signal transmitters 1 are disposed in a store (e.g., a supermarket, a shopping mall, etc.) respectively at different areas, including, for example, a dairy section, a bakery section, etc. In this embodiment, each area displays at least one kind of goods sold in the store. Each of the signal transmitters 1 is configured to broadcast a location identifying data set that indicates the respective one of the areas where the signal transmitter 1 is disposed. In this embodiment, each signal transmitter 1 is, for example, an iBeacon transmitter, and the location identifying data set includes a major value (indicating the store), and a minor value (indicating one of the areas where the respective signal transmitter 1 is disposed). In some embodiments, each of the signal transmitters 1 is configured to broadcast a universally unique identifier (UUID).

The portable electronic device 2 is operable by a user, and is, for example, an iBeacon-compatible device that performs actions when in close proximity to an iBeacon transmitter. The portable electronic device 2 stores a number of total reward points related to the user of the portable electronic device 2, and a plurality of available electronic coupons associated respectively with a plurality of numbers of exchanging points. In some embodiments, the number of total reward points related to the user and the available electronic coupons may be stored in the server 3. In this embodiment, the portable electronic device 2 is a smartphone, but can be other portable electronic devices such as a tablet or a personal digital assistant (PDA).

The server 3 is communicatively connected to the portable electronic device 2, and stores a plurality of pre-stored location data sets (D1) related respectively to the areas in the store, and a plurality of question banks (D2) associated respectively with the pre-stored location data sets (D1). Each of the question banks (D2) is related to goods that are displayed in a corresponding one of the areas, and includes a plurality of questions and a plurality of correct answers respectively corresponding to the questions. For each of the question banks (D2), the questions in the question bank (D2) correspond respectively to a plurality of applicable ages and a plurality of numbers of reward points. For example, the server 3 further stores the applicable ages corresponding respectively to the questions, and the numbers of reward points respectively for the questions. Note that the applicable ages may be the same or different for two or more different questions in the question bank (D2).

The questions can, for example, be related to a subject of English, mathematics or biology. For example, a question related to the subject of English in a question bank (D2) that is associated with the location data set (D1) related to an area displaying beverages asks the user in Chinese “What is the English word for coke?” and the correct answer to this question is “coke.” Table 1 shows some more examples of the questions in the question banks (D2).

TABLE 1

| Area/ | | | | Correct |
|---|---|---|---|---|
| Section | Goods | Subject | Question | answer |
| Daily | Battery | English | What does | ♯22 ♯23 |
| necessities | | | “battery” mean? | (note: |
| | | | | “battery” |
| | | | | in |
| | | | | Chinese) |
| Seasoning | Soy | Mathematics | Assuming a | $207 |
| | sauce | | bottle of soy | |
| | | | sauce costs $69, | |
| | | | how much does it | |
| | | | cost for three | |
| | | | bottles of soy | |
| | | | sauce? | |
| Bakery | Biscuit | Mathematics | Tom has $100. How | $60 |
| | | | much money does | |
| | | | he still have | |
| | | | after he spent | |
| | | | $16 for a pack of | |
| | | | biscuits and $24 | |
| | | | for a pack of | |
| | | | “Lays”? | |
| Meats | Chicken | Biology | How many legs | 2 |
| | leg | | does a chicken | |
| | | | have? | |
| Vegetables | Carrot | Biology | Is carrot a root, | Root |
| | | | stem, leaf or | |
| | | | fruit? | |

A degree of difficulty of each question in the question banks (D2) is positively correlated to years of the applicable age. That is to say, the smaller the years of the applicable age, the lower the degree of difficulty of the question. For example, a degree of difficulty of a question applicable to an age group of those aged 12 years or under is lower than that of a question applicable to an age group of those aged 18 years or above. The following Table 2 shows an example of correspondence between the degree of difficulty and the years of applicable age for a question.

TABLE 2

| Difficulty | Applicable age |
|---|---|
| Low | 12 years or under |
| Medium | 13 to 17 years |
| High | 18 years or above |

For each question in the question banks (D2), the corresponding number of reward points is negatively correlated to the years of the applicable age corresponding to the question. Table 3 illustrates an example of correspondence between the number of reward points and the years of the applicable age, and the present disclosure is not limited in this respect.

TABLE 3

| Number of reward points | Applicable age |
|---|---|
| 100 points | 12 years or under |
| 50 points | 13 to 17 years |
| 25 points | 18 years or above |

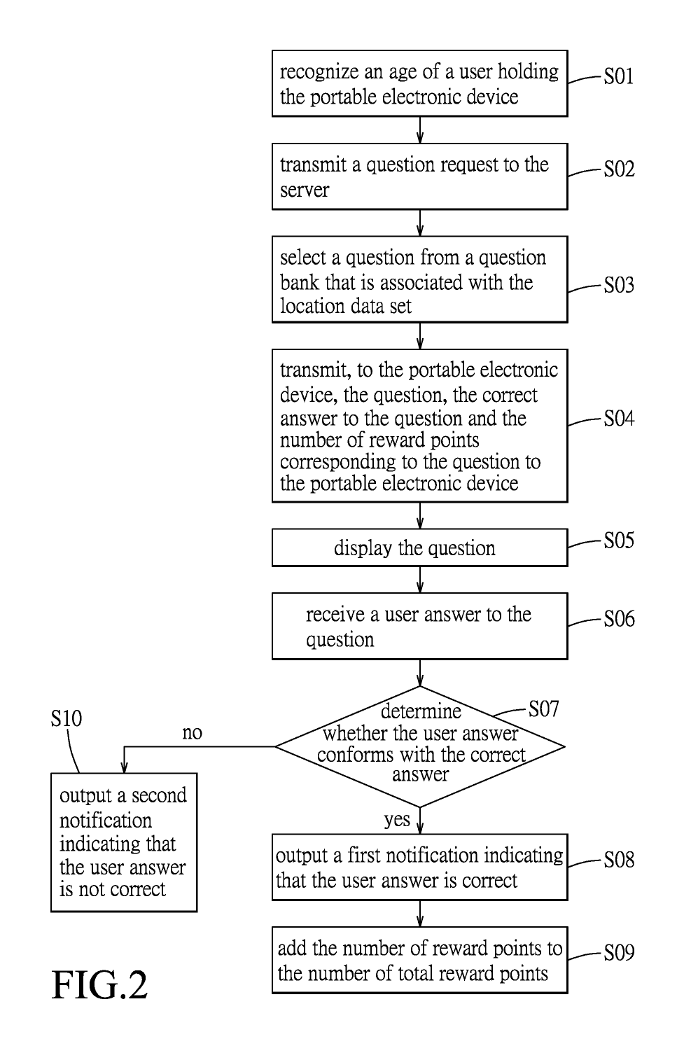

Further referring to FIG. 2, an operation method of the learning system 100 is disclosed and includes the following steps. In step S01, upon receipt of the location identifying data set from one of the signal transmitters 1, the portable electronic device 2 recognizes an age of a user holding the portable electronic device 2. For example, the portable electronic device 2 recognizes the age of the user by performing facial recognition. For example, facial recognition is performed by using techniques involved in How-old.net developed by Microsoft Research. Since the main feature of this disclosure does not reside in the recognition of the age of the user, the details of the same are omitted.

Then, in step S02, the portable electronic device 2 transmits a question request including the location identifying data set and the age of the user to the server 3.

In step S03, the server 3 selects, in response to receipt of the question request, a corresponding one of the question banks (D2) associated with one of the pre-stored location data sets (D1) that conforms with the location identifying data set included in the question request, and selects, from the corresponding one of the question banks (D2), an applicable one of the questions (referred to as applicable question hereinafter) corresponding to one of the applicable ages that conforms with the age of the user included in the question request. Then, in step S04, the server 3 transmits, to the portable electronic device 2, the applicable question, the correct answer to the applicable question and the number of reward points corresponding to the applicable question. In one embodiment, the server 3 transmits, to the portable electronic device 2, a data package including the applicable question, the correct answer to the applicable question and the number of reward points corresponding to the applicable question.

In step S05, the portable electronic device 2 outputs the applicable question in response to receipt of the applicable question, the correct answer thereto and the number of reward points from the server 3. In this embodiment, the portable electronic device 2 displays the applicable question for the user to review and answer the applicable question.

In step S06, the portable electronic device 2 receives, from the user, a user input of a user answer to the applicable question. The user answer can be received via an input interface such as a virtual keyboard displayed on a display of the portable electronic device 2, but the present disclosure is not limited in this respect.

In step S07, the portable electronic device 2 determines whether the user answer conforms with the correct answer to the applicable question. When the portable electronic device 2 determines that the user answer conforms with the correct answer, the flow of the method goes to step S08; otherwise, the flow of the method goes to step S10.

In step S08, the portable electronic device 2 outputs a first notification indicating that the user answer is correct. For example, the portable electronic device 2 displays “Correct” on the display thereof. In step S09, the portable electronic device 2 adds the number of reward points corresponding to the applicable question to the number of total reward points related to the user. Note that, in a case that there are multiple users who are authorized to access the portable electron device 2, the portable electronic device 2 may store a plurality of numbers of total reward points that are related respectively to the users.

For example, the number of reward points corresponding to the applicable question is 100, and the number of total reward points of the user of the portable electronic device 2 is 200 before the user answers the applicable question. Then, the number of total reward points would be 300 when the user answer is correct. Note that steps S08 and S09 are interchangeable in order and may be performed in parallel.

In step S10, the portable electronic device 2 outputs a second notification indicating that the user answer is not correct. When the user answer is not correct, the portable electronic device 2 does not add the number of reward points corresponding to the applicable question to the number of total reward points related to the user of the portable electronic device 2.

In some embodiments, upon receipt of a user input of an exchanging request for exchanging one of the available electronic coupons (referred to as to-be-exchanged coupon hereinafter) with the total reward points the user has (as indicated by the number of total reward points), the portable electronic device 2 determines whether the number of total reward points of the user is not smaller than the number of exchanging points that is associated with the to-be-exchanged coupon. The available electronic coupons are associated respectively with a plurality of numbers of exchanging points, and are displayed on the display of the portable electronic device 2 for the user to select to thereby generate the exchanging request when one of the available electronic coupons is selected. Each of the available electronic coupons is an electronic coupon that is not activated and thus cannot be used yet, and that can be exchanged and obtained by the user for activation and use.

When it is determined that the number of total reward points of the user is not smaller than the number of exchanging points associated with the to-be-exchanged coupon, the portable electronic device 2 activates the to-be-exchanged coupon, and subtracts the number of exchanging points associated with the to-be-exchanged coupon from the number of total reward points to update the number of total reward points of the user of the portable electronic device 2. Once the to-be-exchanged coupon is activated, the to-be-exchanged coupon is stored by the portable electronic device 2 as an activated electronic coupon for subsequent use. For example, the activated electronic coupon can be used in exchange for receiving a specific article, or to have a discount on goods sold in the store. On the other hand, when it is determined that the number of total reward points of the user is smaller than the number of exchanging points associated with the to-be-exchanged coupon, exchanging the total reward points for the to-be-exchanged coupon fails.

To sum up, by virtue of each signal transmitter 1 that broadcasts the location identifying data set indicating the area where the signal transmitter 1 is disposed, the portable electronic device 2 communicates, upon receipt of the location identifying data set, with the server 3 to receive and display a question that corresponds to the age of the user, that is selected from the question bank associated with the location data set conforming with the received location identifying data set, and that is related to goods displayed in the area where the signal transmitter 1 is disposed. Thus, the user can learn knowledge from the displayed question when shopping. Further, the number of reward points corresponding to each question is added to the number of total reward points of the user when the user answer to the question is correct, and the total reward points can be exchanged for an activated coupon stored in the portable electronic device 2 for subsequent use. By this way, parents are encouraged to bring their children to go shopping more often.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An operation method of a learning system, the learning system including a plurality of signal transmitters that are disposed respectively at different areas in a store, a portable electronic device, and a server that stores a plurality of pre-stored location data sets related respectively to the areas in the store and a plurality of question banks associated respectively with the pre-stored location data sets, each of the question banks being related to goods that are displayed in a corresponding one of the areas and including a plurality of questions and a plurality of correct answers respectively to the questions, the method comprising:
broadcasting, by each of the signal transmitters, a location identifying data set indicating the respective one of the areas where the signal transmitter is disposed;
upon receipt of the location identifying data set from one of the signal transmitters, transmitting, by the portable electronic device, a question request including the location identifying data set to the server;
in response to receipt of the question request, selecting, by the server, a corresponding one of the question banks associated with one of the pre-stored location data sets that conforms with the location identifying data set included in the question request;
transmitting, by the server to the portable electronic device, one of the questions included in the corresponding one of the question banks and the correct answer to said one of the questions;
outputting, by the portable electronic device, said one of the questions in response to receipt of said one of the questions and the correct answer thereto;
upon receipt of a user answer to said one of the questions, determining, by the portable electronic device, whether the user answer conforms with the correct answer to said one of the questions;
when it is determined that the user answer conforms with the correct answer to said one of the questions, outputting, by the portable electronic device, a first notification indicating that the user answer is correct; and
when it is determined that the user answer does not conform with the correct answer to said one of the questions, outputting, by the portable electronic device, a second notification indicating that the user answer is not correct.

2. The operation method as claimed in claim 1, for each of the question banks, the questions corresponding respectively to a plurality of applicable ages, a degree of difficulty of each of the questions being positively correlated to years of the applicable age, the method further comprising:
upon receipt of the location identifying data set from one of the signal transmitters, recognizing, by the portable electronic device, an age of a user holding the portable electronic device, the question request transmitted to the server by the portable electronic device further including the age of the user;
wherein transmitting, to the portable electronic device, one of the questions includes selecting from the corresponding one of the question banks an applicable one of the questions corresponding to one of the applicable ages that conforms with the age of the user included in the question request, and transmitting, to the portable electronic device, the applicable one of the questions and the correct answer to the applicable one of the questions.

3. The operation method as claimed in claim 2, each of the questions further corresponding to a number of reward points that is negatively correlated to the years of the applicable age corresponding to the question, the method further comprising:
transmitting the number of reward points corresponding to the applicable one of the questions to the portable electronic device; and
when it is determined that the user answer conforms with the correct answer to the applicable one of the questions, adding, by the portable electronic device, the number of reward points corresponding to the applicable one of the questions to a number of total reward points related to the user of the portable electronic device.

4. The operation method as claimed in claim 3, the portable electronic device storing the number of total reward points and a plurality of available electronic coupons associated respectively with a plurality of numbers of exchanging points, the method further comprising:
upon receipt of an exchanging request for exchanging one of the available electronic coupons with the total reward points, determining, by the portable electronic device, whether the number of total reward points is not smaller than the number of exchanging points that is associated with said one of the available electronic coupons; and
when it is determined that the number of total reward points is not smaller than the number of exchanging points related to said one of the available electronic coupons, by the portable electronic device, activating said one of the available electronic coupons, and subtracting the number of exchanging points associated with said one of the available electronic coupons from the number of total reward points.

5. A learning system comprising:
a plurality of signal transmitters disposed respectively at different areas in a store, each of said signal transmitters being configured to broadcast a location identifying data set indicating the respective one of the areas where said signal transmitter is disposed;
a server storing a plurality of pre-stored location data sets related respectively to the areas in the store and a plurality of question banks associated respectively with the pre-stored location data sets, each of the question banks being related to goods that are displayed in a corresponding one of the areas and including a plurality of questions and a plurality of correct answers respectively to the questions; and
a portable electronic device configured to, upon receipt of the location identifying data set from one of said signal transmitters, transmit a question request including the location identifying data set to said server,
wherein said server is configured, in response to receipt of the question request, to select a corresponding one of the question banks associated with one of the pre-stored location data sets that conforms with the location identifying data set included in the question request, and to transmit, to said portable electronic device, one of the questions included in the corresponding one of the question banks and the correct answer to said one of the questions,
wherein said portable electronic device is further configured to output said one of the questions in response to receipt of said one of the questions and the correct answer thereto, to determine whether the user answer conforms with the correct answer to said one of the questions upon receipt of a user answer to said one of the question, to output a first notification indicating that the user answer is correct when determining that the user answer conforms with the correct answer to said one of the questions, and to output a second notification indicating that the user answer is not correct when determining that the user answer does not conform with the correct answer to said one of the questions.

6. The learning system as claimed in claim 5, wherein, for each of the question banks, said server further stores a plurality of applicable ages corresponding respectively to the questions in the question bank, a degree of difficulty of each of the questions being positively correlated to years of the applicable age,
wherein said portable electronic device is further configured, upon receipt of the location identifying data set from one of said signal transmitters, to recognize an age of a user holding said portable electronic device, and to transmit the question request to said server including the age of the user,
wherein said server is further configured to select, from the corresponding one of the question banks, an applicable one of the questions corresponding to one of the applicable ages that conforms with the age of the user included in the question request, and to transmit the applicable one of the questions and the correct answer to the applicable one of the questions to said portable electronic device.

7. The learning system as claimed in claim 6, wherein said server further stores, for each of the questions, a number of reward points that is negatively correlated to the years of the applicable age corresponding to the question, and said server is further configured to transmit the number of reward points corresponding to the applicable one of the questions to said portable electronic device,
wherein said portable electronic device is further configured to add the number of reward points corresponding to the applicable one of the questions to a number of total reward points related to the user of said portable electronic device when determining that the user answer conforms with the correct answer to the applicable one of the question.

8. The learning system as claimed in claim 7, wherein said portable electronic device is further configured to:
store the number of total reward points and a plurality of available electronic coupons associated respectively with a plurality of numbers of exchanging points;
upon receipt of an exchanging request for exchanging one of the available electronic coupons with the total reward points, determine whether the number of total reward points is not smaller than the number of exchanging points that is associated with said one of the available electronic coupons; and
when it is determined that the number of total reward points is not smaller than the number of exchanging points related to said one of the available electronic coupons, activate said one of the available electronic coupons, and subtract the number of exchanging points associated with said one of the available electronic coupons from the number of total reward points.
